(19) United States
(12) Patent Application Publication
(10) Pub. No.: US 2005/0039555 A1
(43) Pub. Date: Feb. 24, 2005

(54) Precession modulated continuously variable transmission

(76) Inventor: Thomas S. Kerian, Brooklyn Park, MN (US)

Correspondence Address: Anthony G. Eggink;Eggink & Eggink, 3100 First National Bank Building, 332 Minnesota Street, St. Paul, MN, 55101, US

(21) Appl. No.: 10/956,701

(22) Filed: Oct. 1, 2004

Related U.S. Application Data
(63) Continuation-in-part of application No. 10/109,766, filed on Mar. 30, 2002, now abandoned.
(60) Provisional application No. 60/287,698, filed on May 1, 2001.

(51) Int. Cl. F16H 25/08; F16H 23/00; F16D 39/00

(52) U.S. Cl. 74/55; 74/60

(57) ABSTRACT

A precession modulated variable differential transmission having a transfer assembly interposed between a rotational input and output. The continuously variable differential transmission utilizes dampers to induce and control the gyrational and rotational motion of a precessing plate. A core group of elements of the transfer assembly include an axial array of dampers peripherally arranged to engage a swash plate in a torsionally rigid manner. Torque is transmitted via the swash plate to an abutment plate within the transfer case. This differential arrangement produced by interposing the damper array between the input and output results in a swash plate that exhibits the motion of a gyroscope. Its rotational speed is dictated by the prime mover while the gyration component, rotating in the same direction, is modulated by the dampers. As the gyration component alone, is translated to the transfer case, and hence the output, the relationship between the rotating moment and the gyrating moment determines the reduction ratio, and is regulated by controlling the damping rate of the damper array.

This application is a continuation-in-part of Applicant's co-pending U.S. application Ser. No. 10/109,766, filed on or about Mar. 30, 2002, which claims the benefit of Provisional Patent Application Ser. No. 60/287,698, filed on or about Apr. 1, 2001.

### BACKGROUND OF THE INVENTION

This invention relates to a continuously variable transmission assembly that utilizes an innovative process for controlling the reduction ratio, termed by the inventor, “precession modulation”. The precession modulated transmission (PMT) is able to produce a wide range of reduction ratios in a highly controllable, increment-less fashion. Variations in the reduction ratio are produced by converting the rotary motion of the input into the rotating and oscillating motion characteristic of a precessing body. As only the oscillating component is transferred to the output shaft, controlling the frequency of this component, which can be readily varied independent of input speed, varies the reduction ratio. By taking the power input from a motor/engine and splitting it into two discrete outputs, the PMT operates in the fashion of a differential gear changer. Properly controlled, this transmission type is able to direct power to either a fluid output with the fluid set into motion in response to the dampers' interaction with, and regulation of swash plate motion, and/or to an output shaft that is driven by the gyrating motion of the swash plate. Throughout most of the transmission's operating range, the energy consumed by the damping process will be a small fraction of the power transmitted through the system. As such, this is a highly biased differential transmission whereby the hydraulic circuit is intended principally as a control circuit, while the vast majority of the energy will be transmitted through the output shaft.

To date, many proposals for a variety of continuously variable transmissions (CVT) have been published or patented, however, few have demonstrated commercial viability despite the compelling performance potential offered by such a device. For mechanical power transmission applications requiring a broad range of operating ratios, a CVT is, in theory, the ideal solution, offering the potential for optimal efficiency and maximized productivity. The efficacy of these systems, however, has produced mixed results due to the many trade-offs resulting from one or more serious limitations.

The most prevalent form of continuously variable transmissions on the market today is the hydrostatic transmission (HST). HST's fill a wide range of applications and power levels, however their efficiency tends to be comparatively poor. This inefficiency manifests itself in the large heat exchangers that are typically necessary to dispose of waste energy created by their operation. HST's also produce undesirable high noise and vibration levels inherent to their dependency on the high volume flow of a pressurized hydraulic medium. They also tend to be quite expensive and therefore are reserved primarily for high end, industrial or capital equipment applications.

The hydrostatic type can be divided into subgroups: the hydrodynamic type, and the positive displacement type. Positive displacement HST's are characterized by a pump driven by a prime mover, which serves to pressurize a hydraulic fluid. This charged fluid is than delivered to a hydraulic motor that converts this energy back into a mechanical form able to perform work on the assigned load.

In many industrial applications, the ability to remotely mount the prime mover and pump from the motor and load is a significant advantage. This is particularly true in the case of industrial, off-road, construction and agricultural machinery where a limited speed range and/or the distribution of power to ancillary systems, separate from the propulsion systems, are significant considerations. In addition to the benefit of continuous variability, the HST is also able to handle high power levels with a relative immunity to shock and overload conditions. This constitutes the primary reason that it is the transmission of choice in applications of this type. However, because of their comparatively poor efficiency, objectionable noise and the substantial space required by supporting systems for cooling, conditioning and filtration of the hydraulic fluid, it has had little impact on other markets.

To date a number of developments have been introduced to address the various shortcomings in conventional HST's. Much research has been centered upon development of the integrated hydrostatic transmission (IHST). The thrust of this development effort has been toward the integration of the pump/motor into a single casing or composite assembly and sharing as many components as possible. The intent is to minimize size and production cost by reducing the number of components required in the device, while improving operating efficiency by minimizing losses from hydraulic friction. The resulting IHST's are compact, highly controllable CVT's that have found acceptance in a range of products. Although the most efficient of displacement type HST's, maximum efficiency is still only in the mid 80% range. Also, due to the fact that fluid pressure and volume are at or near maximum at operating speed, significant noise and vibration typically results. They also consume excessive amounts of fuel and generate considerable amounts of heat. The ensuing stress on the hydraulic fluid in this hot, high pressure environment necessitates a rigorous maintenance schedule and the over sizing of systems to deal with the filtration of the fluid, as well as the removal of entrained gasses and excess heat.

### SUMMARY OF THE INVENTION

A precession modulated transmission for reduction ratio control between rotational inputs and outputs. A precessable structure is interposed between a rotatable input and a rotatable output. The precessable structure is rotatable and oscillatable. The precessable structure comprises a swash plate and cooperating abutment plate. The swash plate is oscillated by a plurality of damping elements which modulate the precessing motion of the interposed precessable structure to control the reduction ratio between the input and output. The precession modulation control assemblies of the invention are provided for use as a continuously variable differential transmission.

The continuously variable differential transmission of the invention is for a prime mover, such as an engine or motor. The variable differential transmission comprises a torsionally rigid input assembly, a transfer assembly, means to maintain a collinear relationship between the input assembly and the transfer assembly and means to regulate a damper rate. The torsionally rigid input assembly is constructed and arranged for rotational communication with the prime mover. The input assembly has a rotational axis, a carrier device at one end and a swash plate at the opposite end. An array of dampers are secured to the carrier device and act upon the swash plate. The transfer assembly has an abutment plate constructed and arranged to communicate with the swash plate of the input assembly. The means to maintain the collinear relationship between the input assembly and the transfer assembly is constructed and arranged to impart a sequential compression and relaxation of the dampers of the damper array at a predetermined damper rate to thereby impart a precessing motion to the swash plate. The means to regulate the damper rate regulates the precession motion of the swash plate. The damper rate may be controlled by hydraulic means whereby a housing assembly with control and return circuits, are provided. A valve plate and means to regulate the hydraulic pressure are provided to act on the array of piston dampers, for example. The housing assembly may have a plurality of ports for hydraulic fluid flow and the valve plate moves hydraulic fluid through the ports via the control and return circuits of the transmission housing.

The advantage of the precession modulated transmission of the invention is that it provides a compact speed reducing structure that is easily incorporated into a power system. The precession modulated transmission of the invention provides an efficient, low cost and low maintenance structure that provides a broad range of reduction ratios.

A further benefit of the precession modulated transmission of the invention is its ease of manufacture, assembly and reliability. The transmission of the invention further provides improved torque transmission characteristics, is tolerant to shock and overload conditions and is scalable for a variety of uses.

The precession modulated transmission is an invention offering significant advantages in power transmission by virtue of a compact design that is easily integrated into power trains. Further benefits include significant improvements in efficiency by the elimination of the pump-motor relationship of prior art axial piston and of bent axis HST's. This distinct departure from the prior art also imparts benefits concerning torque transmission. Further, the damper control system of the transmission may be used as an auxiliary power source.

These and other benefits of this invention will become clear from the following description by reference to the drawings.

### DESCRIPTION OF THE DRAWINGS

FIG. 1 is a sectional view showing the preferred embodiment of the Precession Modulated CVT in accordance with the present invention;

FIG. 2 is a diagram depicting the swash plate's principal axis of rotation;

FIG. 3 is a diagram depicting the swash plate's principal axis of rotation;

FIG. 4 is a schematic of a hydraulic control circuit with provisions for the cooling and filtration of the hydraulic fluid, while providing power to auxiliary systems;

FIG. 5 is a cut away view of the transmission showing the internal porting arrangement;

FIG. 6 is a force diagram demonstrating the basic principle behind precession modulation, and how it is able to compound torque through the reduction process;

FIG. 7 is a graph that demonstrates how fluid displacement varies in proportion to the reduction ratio;

FIG. 8 depicts a graph that plots the anticipated speed and reduction ratio operating range;

FIG. 9 is an index describing the elements or components that make up an embodiment in accordance with the present invention;

FIG. 10 is an exploded view of the components of a Core Group in accordance with the present invention;

FIG. 11 is an exploded view of the components of a transfer case group in accordance with the present invention;

FIG. 12 is an exploded view of the components of a housing group in accordance with the present invention;

FIG. 13 is a lateral, cut-away view showing a transfer case assembly with a variable abutment plate and linkage for adjustment of the swash angle; and

FIG. 14 is an exploded view showing the components of embodiments of the core group, transfer case group and housing group of the invention.

### DETAILED DESCRIPTION OF THE INVENTION

The present invention relates to a precession modulated continually regulated transmission (PMT). Embodiments of the PMT, the precession modulation control assemblies and the methods of operation are shown in the drawings and discussed as follows.

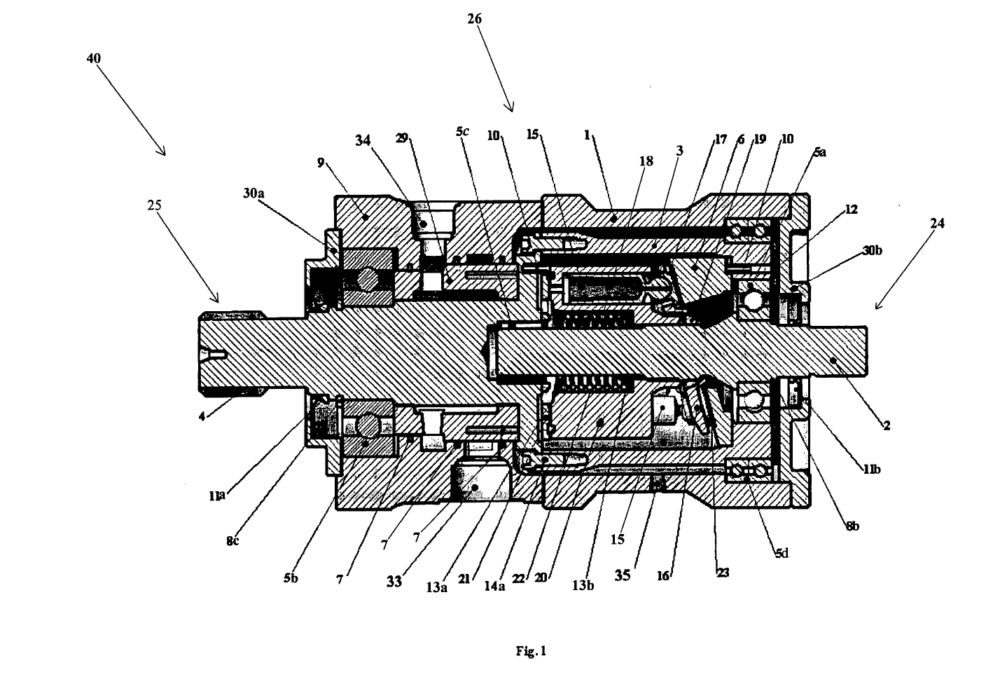

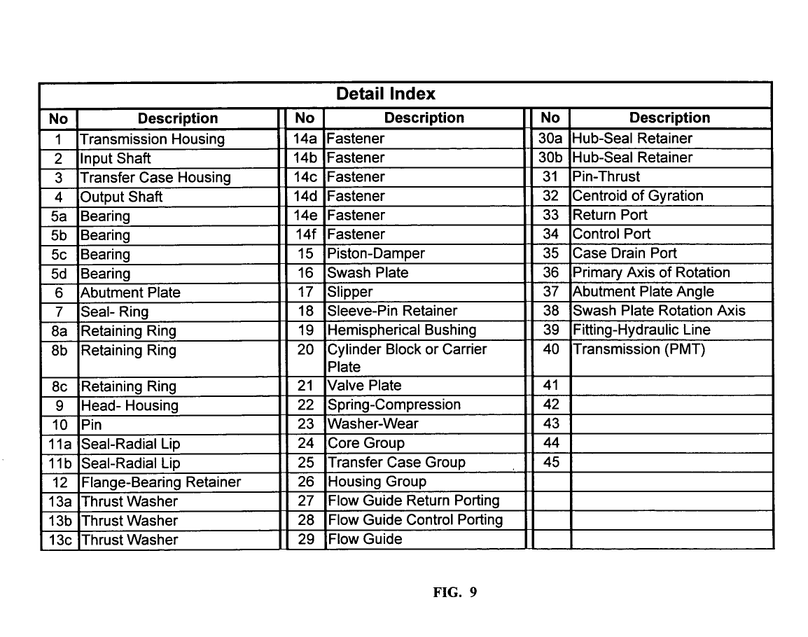

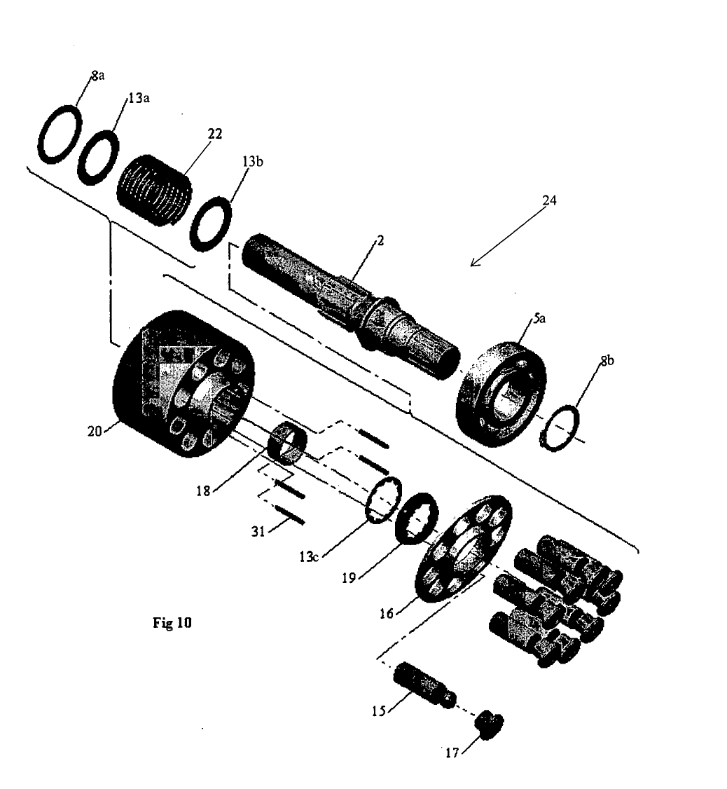

As shown in FIG. 1, an embodiment of the PMT has three principal component groups coaxially arrayed. At the center of the transmission 40 is a core group 24 enclosed by a transfer case group 25. Surrounding the core group 24 and the transfer case group 25 is the housing group 26. The core group 24, transfer case group 25 and housing group 26 are comprised of various parts set forth in FIG. 9, and are further discussed below with respect to FIGS. 10, 11 and 12, respectively, and are shown cooperating together in FIG. 1.

The preferred embodiments of the core group 24 use a hydraulic medium for damping with a system of damper pistons 15 axially arrayed within a cylinder block or carrier plate 20 to which power is imparted by a motor or engine (prime mover not shown) through the input shaft 2. As hydraulic fluid is put into circulation by the damper pistons 15, regulation of the damping rate allows a means for controlling how power is distributed between the oscillating and rotating circuits. The fluid enters and exits the transmission's housing group 26 for control and conditioning purposes via ports 33 and 34 in the housing head 9.

As shown in FIGS. 1 and 12, transmission housing group 26 is shown comprising housing head 9 and housing 1, held together using fasteners 14e. Seal retainer hub 30a is shown for attachment to housing head 9 using fasteners 14d and seal retaining hub 30b is shown for attachment to housing 1 using fasteners 14f. Radial lip seals 11a and 11b are shown disposed within seal retaining hubs 30a and 30b, respectively. Further, ring seals 7 are shown for positioning within housing head 9.

Referring to FIG. 10, the core group 24 used in the transmission of the invention is similar in construction to rotary groups found in prior art forms of axial piston hydraulic motors. As such, being a mature technology, this aspect of the PMT will be covered in a cursory fashion.

While the core group 24 finds antecedent basis in prior art axial piston HST's, the PMT of the present invention employs this arrangement in a novel fashion as an array of dampers, shown in FIGS. 1 and 10 as piston dampers 15. The well documented performance characteristics of such devices provide a strong basis for projecting the performance characteristics and operating range in their new role as dampers.

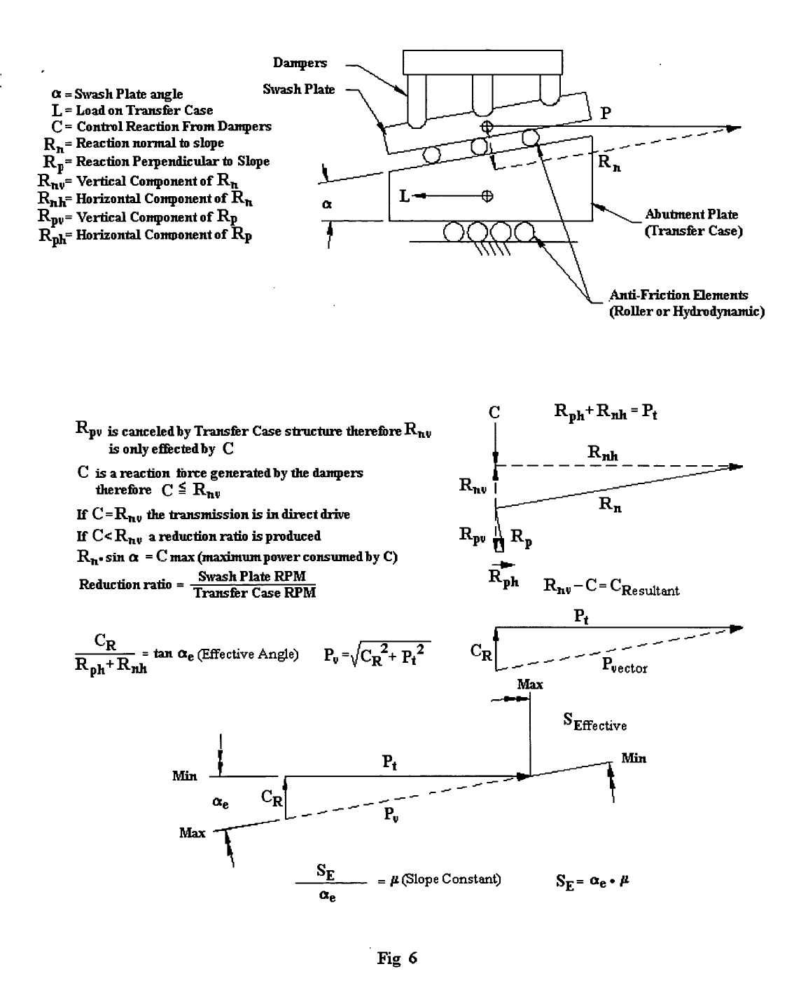

Unique to this invention is the inclusion of a transfer case group 25 between the core group 24 and the housing group 26, as shown in FIG. 1. Since the piston-dampers 15 provide a reaction force to the speed differential between the transfer case 25 and the core group 24, through the inclination of the abutment plate 6, this arrangement induces the transfer case 25 to rotate with the core group 24. The translations of forces at this interface are outlined in FIG. 6, as further discussed below, and induce a range of motion upon the swash plate 16 that is characteristic of a gyroscope precessing about its main axis.

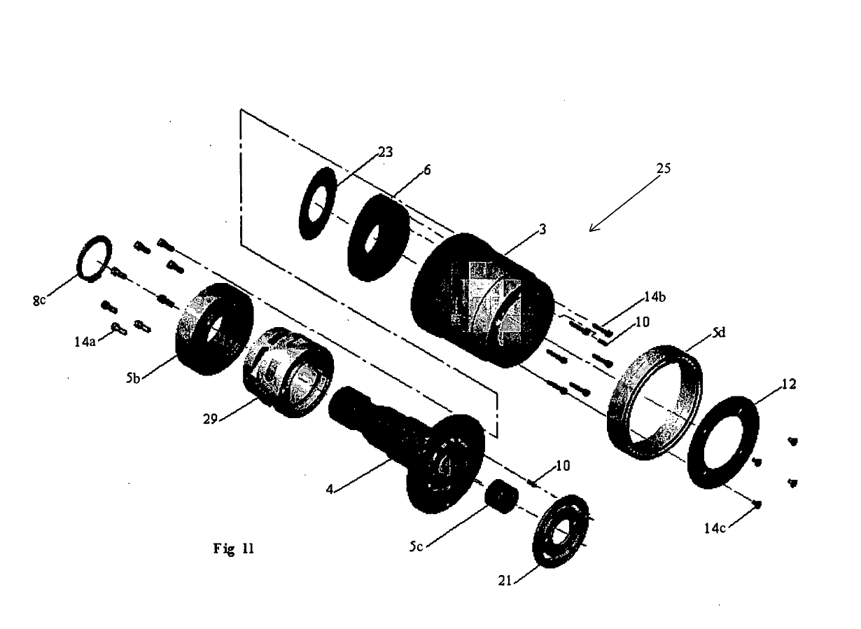

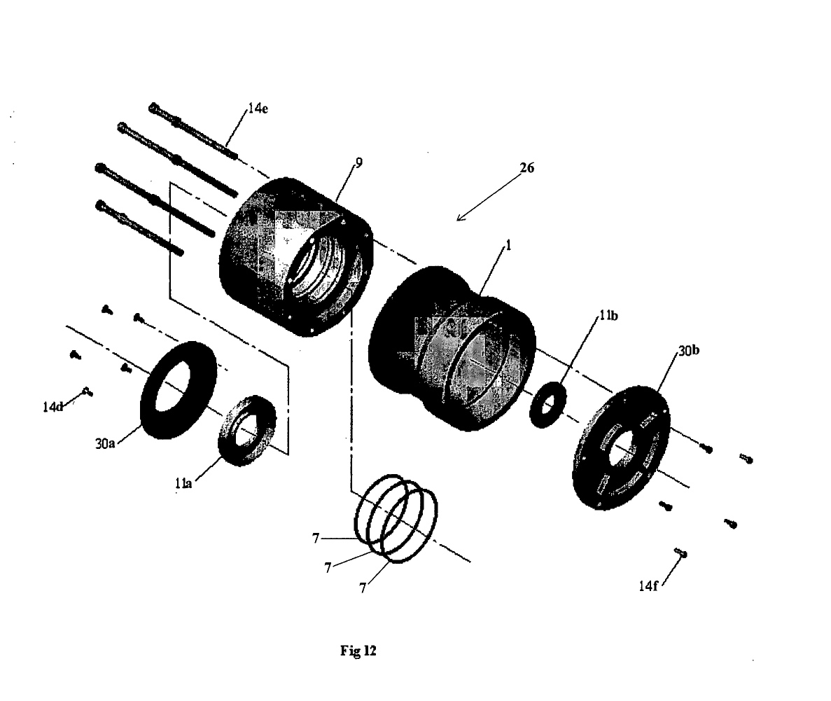

In operation, the hydraulic fluid that circulates via the alternately expanding and compressing piston-dampers 15 passes through a valve plate 21, the orientation of which is clocked with a specific orientation to the abutment plate 6 to provide a control circuit and return circuit. This particular embodiment is driven in a counter-clockwise direction as viewed from the output end of the transmission. As the pistons-damper 15 ramp up the abutment plate 6 and are progressively compressed, they discharge the hydraulic fluid through the valve plate 21. This phase, in which the piston 15 is rising up the abutment plate 6, constitutes the damping phase. There is a corresponding set of ports in the valve plate 21 (as shown in FIG. 11) arrayed 180 degrees out of phase with first said ports. These ports are dedicated to the replenishment of fluid during the return phase that ensues after the piston 15 reaches the top of its stroke within the cylinder block 20 and commences to travel down the backside of the abutment plate 6. At this time, these ports provide a path for the return of fluid to the piston-dampers 15.

Although piston dampers 15 and a cooperating cylinder block 20 are discussed for use in the variable transmission, other dampering means operative on the swash plate may be utilized within the purview of the present invention. For example, individually mounted pistons acted upon by a fluid, i.e., liquid or gas, or electromagnetic means.

FIG. 11 shows the transfer case group 25 containing the abutment plate 6 and valve plate 21. A pin 10 is used to align the valve plate 21 to the output shaft 4 which is also fixed in radial alignment by two pins 10 to the transfer case housing 3. The abutment plate 6 is similarly pinned in orientation using fasteners 14b, with all the components bolted into a rigid assembly that contains the core group 24 depicted in FIGS. 1 and 10. Further, bearing 5d and bearing retainer flange 12 are shown constructed and arranged for attachment to transfer case housing 3 using fasteners 14c. Bearing 5c is shown positioned for use with output shaft 4 and valve plate 21. Retaining ring 8c and bearing 5b are shown positioned for cooperation with flow guide 29 and output shaft 4. Fasteners 14a are shown provided for attachment of output shaft 4 to transfer case housing 3.

Core group 24 and transfer case group 25 are shown in FIGS. 10 and 11, respectively, having various parts and in FIG. 1 positioned together in a cooperating fashion. The core group 24 is located via bearings 5a-d to allow free rotation within transfer case group 25. As further shown in FIGS. 1 and 10, the axial location of these components is maintained by a spring 22 that provides a pre-load to the swash plate 16 via thrust pin 31 and a hemispherical bushing 19. This arrangement allows the swash plate 16 to capture the slippers 17, forcing them into contact with the abutment plate 6, with wear washer 23 acting as an intermediary. Counterbalancing the thrust forces generated here is the hydrodynamic interface between the valve plate 21 and the cylinder block 20, with careful attention paid to insure that the hydrodynamic forces generated at both junctures maintain a certain parity.

Referring further to FIGS. 1 and 10, core group 24 is shown having bearing 5a and retaining ring 8b which are shown positioned for cooperation with input shaft 2. Spring 22 is shown positioned between thrust washers 13a and 13b and for positioning within cylinder block 20 and for use with pin retainer sleeve 18 and thrust pins 31. Retaining ring 8a is shown positioned for cooperation with thrust washer 13a. Thrust washer 13c is shown positioned for cooperation with hemispherical bushing 19.

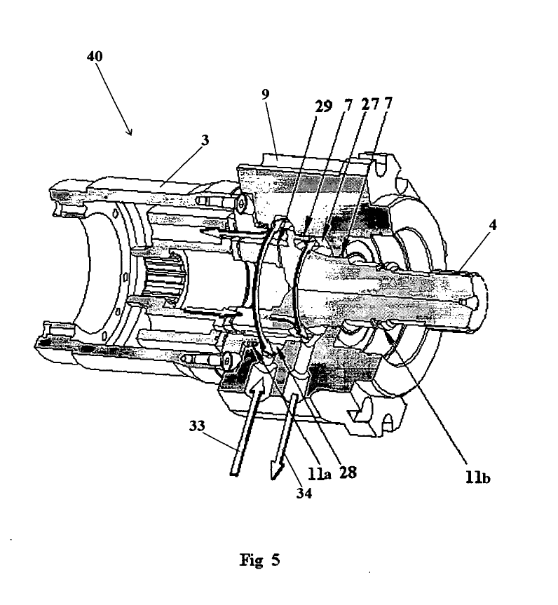

As shown in FIG. 5, the output shaft 4 is ported in a manner so as to discharge the fluid passing through the valve plate 21 into the flow guide 29 that terminate in annular passages 27 and 28 and from which the hydraulic fluid exits the transmission though control and return ports 33 and 34. Radial lip seals 11a and 11b and ring seals 7 are further shown in FIG. 5.

The annular control port 28 is flanked on both sides by ring seals 7 as pressure in this cavity may reach several kpsi. Any leakage past ring seal 7 will pass into the output side and provide lubrication for an output shaft bearing 5b. This cavity is sealed by means of O-rings and radial lip seals 11 held captive by flange-seal retainer 12 and fasteners 14c, with excess fluid discharging to the housing, which is at atmospheric pressure. Any fluid bypassing ring seal 7 will cross over to the return port and return to the dampers. From here, the hydraulic fluid exits the transmission though ports that are threaded to accommodate hydraulic fittings to a control circuit (see FIG. 4).

FIG. 4 provides a schematic of an open loop circuit that features components for cooling and filtration purposes. It also features a control circuit in series with a PTO system driven by a small hydraulic motor. In many applications, not all the components shown in this schematic of FIG. 4 would be required. In addition, some of the features could be incorporated into the transmission itself. This increased integration is more easily achieved than in the conventional displacement HST, principally because of lower heat generation and much lower average fluid displacement in most operating regimes.

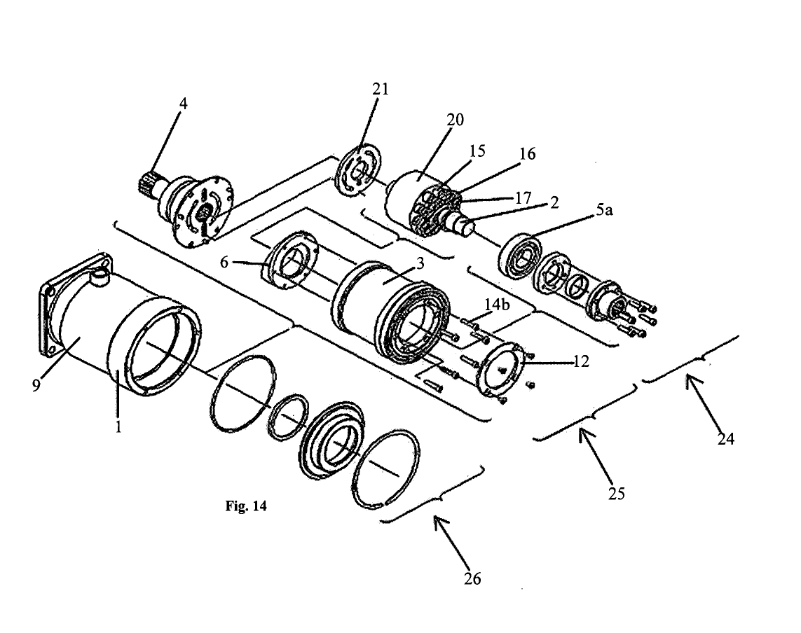

Referring to FIG. 14, an exemplary transmission is shown, showing how the housing group 26, transfer case group 25 and core group 24 fit together into a cooperating assembly. Housing head 9 and housing 1 are shown for containing transfer case group 25 and core group 24. Input shaft 2 is shown cooperating with cylinder block or carrier plate 20 and swash plate 16, which are shown cooperating with damper pistons 15 and slippers 17. Abutment plate 6 is shown provided to cooperate with swash plate 16, both being for placement within transfer case housing 3, along with cylinder block 20. Valve plate 21 is shown provided for placement between output shaft 4 cylinder block 20.

Although the variable transmission and precession modulated control assembly according to the teachings of the invention may have various forms, the design depicted in the drawings is in accordance with an embodiment that is intended for applications with a speed range of 400 to 4000 RPM's and torque to 100 lb/ft. It is anticipated that the transmission will produce reduction ratios to 5:1 with acceptable efficiency. An input of 2500 RPM's may represent the practical upper range over which the transmission's full range of reduction ratios can be utilized. Input speeds in excess of 3500 RPMs will probably be limited to reduction ratios of less than 2:1. Reduction ratios below 3:1 should exhibit levels of efficiency and torque transmission characteristics comparable to the sophisticated transmissions used in modern automotive applications. As depicted in FIG. 8, this design achieves maximum efficiency at ratios approaching direct drive, a point where the transmission would essentially function as a coupling producing a top efficiency in the mid 90% range. This level of efficiency will drop off progressively as the reduction ratio goes up, with the efficiency likely falling below 80% at ratios exceeding 4:1.

This departure from the conventional mode of operation exhibited by prior art axial piston HST's produces significant enhancements in performance as well as an entirely different mode of operation.

The PMT of the invention differs from prior art HST's in that it provides a direct mechanical input and output arrangement. As illustrated herein, for example in FIG. 1, the preferred embodiment consists of a collinear input and output shaft on opposite ends of a compact housing case. While similar to the integrated hydrostatic transmission in this respect, the PMT is able to achieve a significantly smaller form factor due to the elimination of the pump-motor relationship typical of the prior art discussed above.

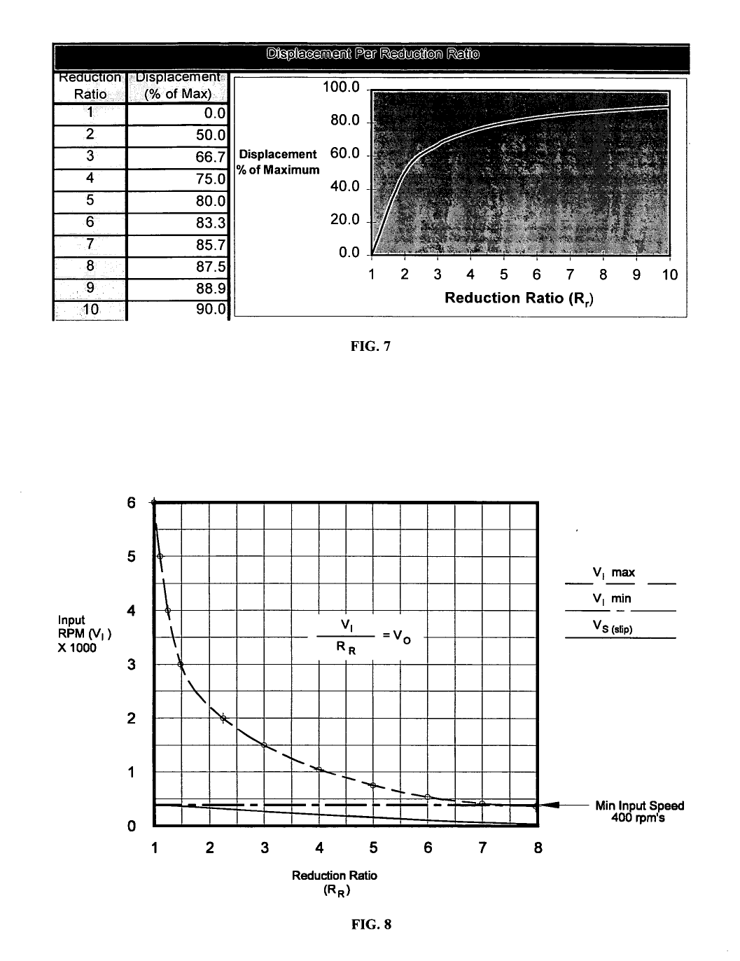

The PMT of the present invention also makes a significant departure from prior art HST's in the method of operation used to vary the transmission's displacement as well as the relationship of fluid flow to duty cycle. In the PMT, the flow rate of the hydraulic medium is inversely proportional to output speed. This results in an effective displacement that falls off rapidly as the transmission approaches direct drive, at which point the transmission becomes a direct mechanical coupling. This is shown in FIG. 7. However, losses from leakage will invariably impact volumetric efficiency, producing a certain degree of slippage in the absence of secondary systems to counter or compensate for such losses, much as hydrostatic transmissions require the use of charge pressure or make-up pumps to insure stability when at operating extremes.

This inverse flow rate is a result of the PMT's employment of a unique differential transmission function, whereby the rotational components, while coaxially arrayed in the preferred embodiment, possess a common moment of rotation. While beneficial in preventing excessive RPM's by summation of shaft speeds, a more pertinent consideration is preventing the conflicting moments of torque that would result from the retrograde precession of a comparable design utilizing the conventional approach of driving the transmission with a charged fluid provided by an external source.

This differential function is achieved by means of a transfer case 25. While the core group 24 is typically coupled directly to the prime mover, and rotates at a speed dictated by this driver, the transmission's output is derived from the transfer case. When provided with positive power input, the output speed and rotational velocity of the core group will range from zero rpm's to parity with the prime mover. The transfer of forces between these two major assemblies occurs across the juncture of the swash plate 16 and abutment plate 6, and is regulated by an axial array of piston dampers 15 with porting that permits a hydrodynamically balanced force between the cylinder block 20 and the valve plate 21. FIGS. 1 and 10 further show a ported piston that permits a counterbalancing pressure to be applied to the abutment plate 6 through the slipper 17, insuring a hydrodynamic, full film lubrication between these thrust bearing members.

The preferred embodiment of this invention utilizes a damper system employing a piston 15 in the fashion of expansible chamber devices, however, any component able to produce a constant resistance throughout a range of linear motion could serve in this capacity, provided it is also possible to vary the damping rate as a means to regulate the reduction ratio.

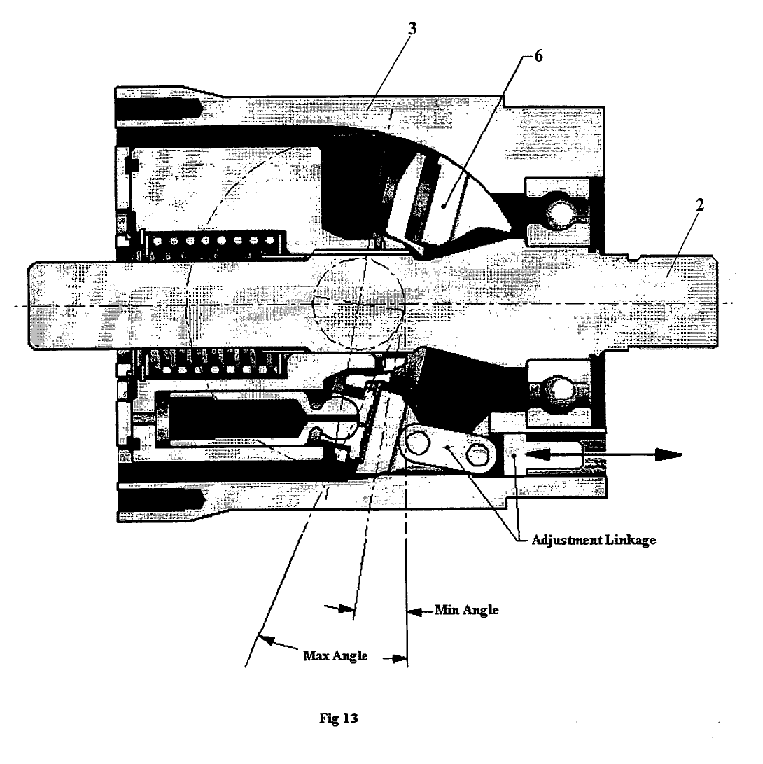

As dampers, these pistons 15 no longer serve as the driving elements typical of their function in a hydraulic motor, but instead provide a reaction force to the speed differential between the prime mover and the load. More specifically, their function is to modulate the gyration frequency of the swash plate 16. The range of motions exhibited by the swash plate as further shown in FIG. 13 is unique to this invention and warrant the more descriptive term of precession plate, favored by the inventor. This is an appropriate term, given the fact that this plate 16, while rotating at a speed dictated by the prime mover, precesses in the same direction at a reduced speed. It is the function of the dampers to regulate precession frequency, with precession frequency determining final drive ratio. As further shown in FIG. 13, the adjustment linkage mechanism allows the angle of the abutment plate 6 to be to be varied. The minimal angle and the maximum angle range, i.e., approximately 10-30 degrees, affects the modulation of the swash plate 16. The preferred angle, i.e., 15° for a variable transmission, as described herein, is related to the duty cycle of the transmission. Once adjusted, the abutment plate 6 is fixed at the set angle, whereas the swash plate 16 freely pivots on a hemispherical bushing, for example.

The PMT's control system works by effectively changing the angle of the swash plate 16, producing an effect similar to a gradual and progressive change to the slope of an inclined plane. The preferred embodiment is able to create the effect of an inclined plane that can be varied from the physical slope (15 degrees in the embodiment depicted here) to 90 degrees even though the physical slope remains constant. FIG. 6 is a two-dimensional force diagram representing the power transmission process and demonstrating how the dampers 15 can modulate the reduction ratio. As can be seen from FIG. 6, the dampers create a force “C” that varies the effective slope (S_{E}). These dampers 15 as well as the swash plate 16 are part of the core group 24, and rotate as an assembly at a speed determined by the driving motor. These pistons no longer serve as the driving elements typical of their function in a hydraulic motor, but instead, provide a reaction force to the speed differential between the prime mover and the load. The gyrational component is a result of the modulation process introduced by the pistons' damping effect, with the potential to vary the swash plate gyration frequency from zero to parity with rotation. The former state is the result of the dampers operating with a minimal damper rate, resulting in no output. The latter state provides sufficient hydraulic pressure to prevent the dampers from cycling (the dampers would be essentially incompressible) and result in the transmission operating in direct drive. As the gyrational component alone is transmitted to the output shaft, the ratio of the rotary speed of input to that of the output determines the reduction ratio. This damping process also insures the swash plate 16 effectively engages the abutment plate 6, permitting the dynamic translation of forces across this junction. As depicted in FIG. 6, if the reaction force C, generated by the dampers equals R_{N} the transmission will be in direct drive. If the damper rate is gradually reduced by increasing fluid flow through the control circuit shown in FIG. 4, a commensurate reduction in the pressure differential of the control circuit (ΔP) will result. This reduction in pressure differential will produce an increase in the reduction ratio. Conversely, if the load on the output shaft is increased, the reduction ratio will decrease accordingly.

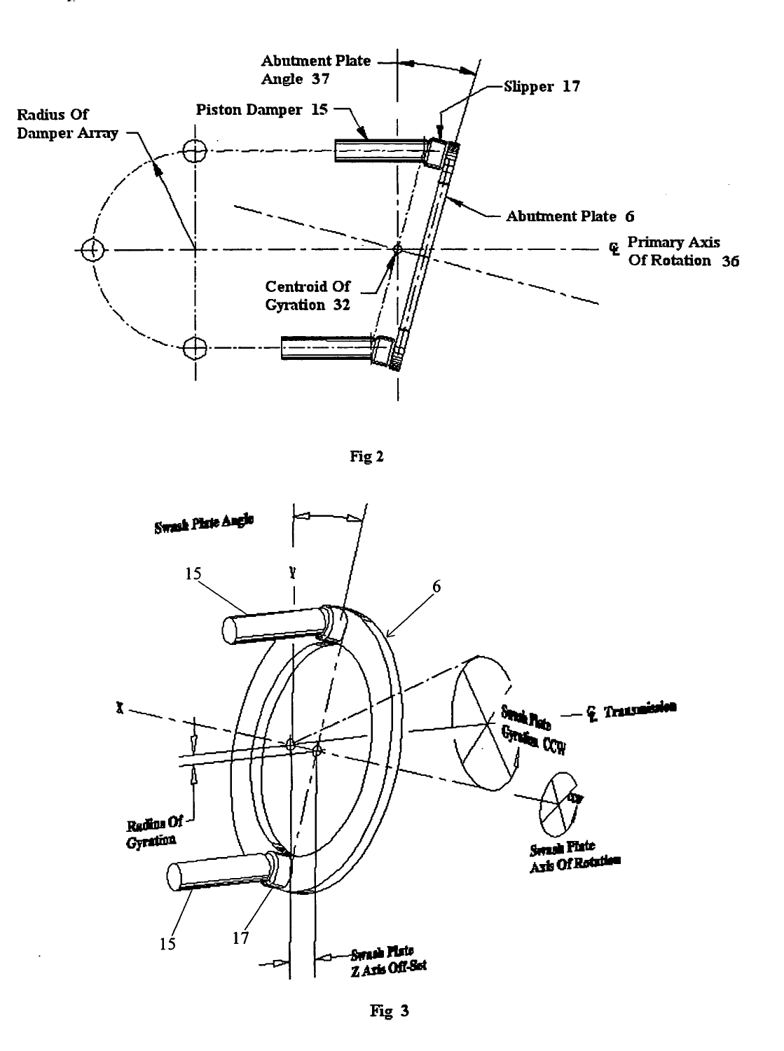

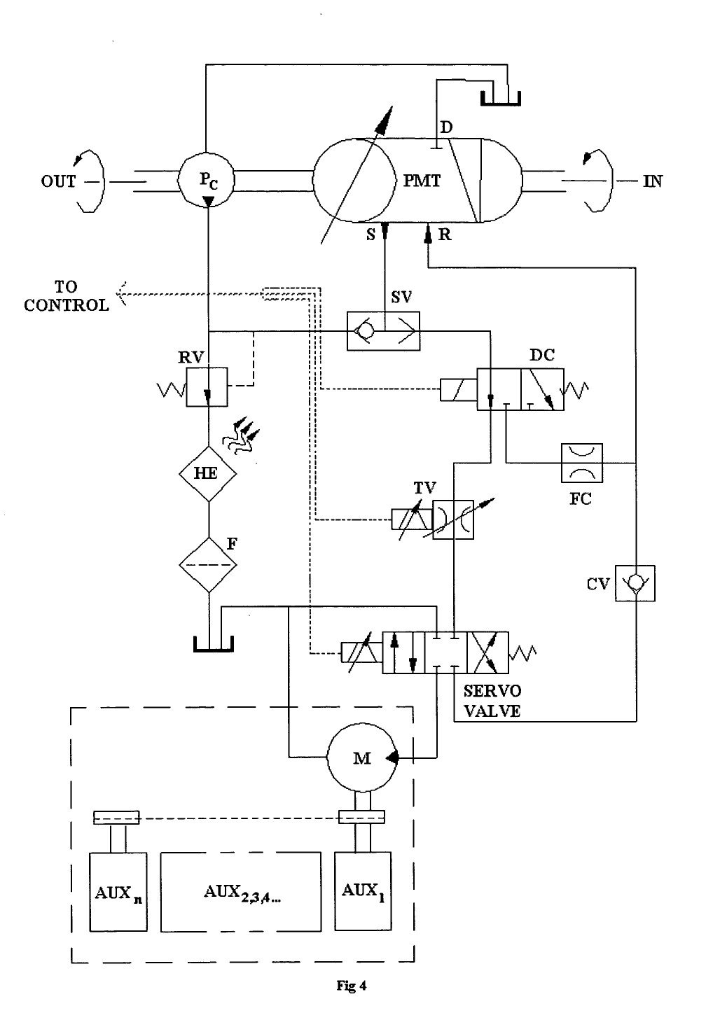

Unique to this invention is the manner in which the swash plate 16 exhibits a range of motions characteristic of a precessing body, as it interacts with the abutment plate 6. Typical of such motion, the swash plate exhibits two axis of rotation, as shown in FIGS. 2 and 3. The primary axis Z is collinear with the transmission centerline, while the secondary axis theta, intersects at an acute angle with the point of intersection coincident with the swash plate's 16 centroid of gyration 32 and at a right angle to the face of the abutment plate 6.

The core group's 24 rotation speed is dictated by a motor or prime mover (not shown) providing a torsionally ridged interface with the transfer group 25. However, the piston-dampers 15, located within the cylinder block 20, provide the degree of axial motion necessary to insure that the swash plate 16 remains square to the abutment plate 6, thereby providing a positive pre-load pressure between the slipper 17 and the abutment plate 6. Consequently, an equal reaction load between the valve plate 21 and the cylinder block 20 on the opposite end of the assembly is produced. As both interfaces provide a hydrodynamic-bearing surface, a certain speed differential between the transfer case and core assembly is called for to maintain proper lubrication. This fact is depicted in FIG. 8 which indicates a minimum input speed and also effectively prevents the PMT from operating in direct drive. However, given a sufficient pressure differential and a certain minimum speed differential, this arrangement should provide a very smooth, quiet and responsive method of power transmission with minimal wear on internal components. Within this operating range the PMT will seek the appropriate reduction ratio when loads change on either the output, control circuit or power input, due to its positive, self-centering stability.

In addition to speed constraints imposed by the need for hydrodynamic lubrication, which is characteristic of all axial piston HST's, the PMT also requires a certain speed differential to insure a sufficient pressure drop across the hydraulic control circuit. This is due to the fact that the PMT displaces no fluid in direct drive. Essentially its displacement has fallen to zero. As the design approaches direct drive, losses from internal leakage will impact the dampers' ability to retain sufficient pressure to maintain the transmission in a locked state (see FIG. 8). These losses are a result of limitations in volumetric efficiency. Given the PMT's similarity to axial piston motors with respect to the core group, it is expected that a comparable level of volumetric efficiency Eᵥ is obtained with the PMT. As a typical axial piston motor experiences a volumetric efficiency of approximately 95%, this efficiency may be used as a basis for projecting a minimum reduction ratio that can be achieved without auxiliary systems to compensate for such losses. As in a typical HST, the PMT's efficiency is largely the sum of EV and losses from heat/friction E_{parasitic} (Eₚ) however, a positive displacement HST requires the overhead of both a pump and a motor, with both components producing comparable levels of efficiency. As such a conventional HST will see efficiencies in the mid to low 80% range. The control system in the PMT, however, should expend a maximum of 17% of power input at a reduction ratio of 5, with the remainder due to losses from Eᵥ+Eₚ.

In summary, the embodiment of the PMT depicted in the drawings and described herein employs an array of piston dampers 15 to regulate the rotation rate of the transfer case group 25. The rotational speed of the output can be varied from zero rpm's to near parity with input speed. When the damping rate is at a minimum and the output shaft has a sufficient load to prevent rotation of the output shaft, the PMT's displacement (in³) is at its maximum. Under these conditions, the swash plate 16 will rotate at a speed dictated by the driver, however, as the abutment plate 6 is stationary, only the swash plate will rotate. The oscillating components, which, in conjunction with the rotary motion typical of a precessing body, at this point, do not exist. Consequently, each revolution of the input shaft produces a complete cycle of the piston dampers. The amount of damping force generated by the modulators at this point, can be determined by the formula L_{O}=ΔP*D. With respect to the PMT, this expression is valid only when there is no rotary output. At this point, the transmission is stalled and is producing maximum displacement. Flow volume is the product of displacement and RPM's, while system pressure is a function of the load (L_{O}) on the output shaft, and although appearing counter-intuitive until considering that L_{O} is a reaction to torque input (L_{I}), which is directly proportional to the control reaction (C) shown in FIG. 3.

The PMT in this extreme mode of operation operates in the same fashion as a swash plate variant of an axial piston pump. This operating mode with respect to the PMT would typically represent a neutral mode. Here the system pressure (Pₛ) is very low and the pressure drop (ΔP) is approaching minimum allowable levels (less than 100 psi). This mode of operation may also be useful when driving auxiliary circuits. With the output shaft locked, all power output may be exported through the control circuit, while engine speed may be varied in accordance with flow volume and pressure requirements.

The components of the precession modulated continuously variable transmission of the present invention are constructed of and use materials which are commonly used in known C.V.T. assemblies.

As many changes are possible to the precession modulated continuously variable transmission assembly of this invention utilizing the teachings thereof, the descriptions above, and the accompanying drawing, should be interpreted in the illustrative and not in the limited sense.

1. A continuously variable differential transmission assembly comprising:
a) a rotational input means;
b) a rotational output means; and
c) a precession modulation control assembly being interposed between said input means and said output means and having a damping means for converting the rotary motion of said input means into rotating and oscillating motion characteristic of a precessing body, wherein said damping means modulates the oscillating frequency and transfers said oscillating motion to said output means.

2. The continuously variable differential transmission assembly of claim 1, wherein said output means includes a transfer case assembly.

3. The continuously variable differential transmission assembly of claim 2, wherein said transfer case assembly includes an abutment plate.

4. The continuously variable differential transmission assembly of claim 3, wherein said damping means includes an axial array of dampers.

5. The continuously variable differential transmission assembly of claim 4, wherein said array of dampers are piston dampers.

6. The continuously variable differential transmission assembly of claim 2, wherein said input means includes a swash plate.

7. The continuously variable differential transmission assembly of claim 3, wherein said abutment plate is adjustable.

8. The continuously variable differential transmission assembly of claim 2, wherein said damping means includes damping rate control means.

9. The continuously variable differential transmission assembly of claim 1, wherein said damper rate control means comprises hydraulic means.

10. The continuously variable differential transmission assembly of claim 9, wherein said hydraulic means includes a housing and an external hydraulic control and conditioning circuit.

11. A precession modulation control assembly for a continuously variable transmission having a rotatable input and a rotatable output, said assembly comprising:
a) a transfer assembly having a precessing body constructed and arranged to rotate and oscillate and being in communication with the rotatable input;
b) an array of dampers having a plurality of damper devices arranged in a axial pattern, said array of dampers communicating with said precessing body;
c) a rotatable drive body in communication with said precessing body, said drive body being in communication with the rotatable output; and
d) means to control the damping action of said array of dampers.

12. The precession modulation control assembly of claim 11, wherein said precessing body is a swash plate, wherein said damper devices are hydraulic piston structures, wherein said drive body is an abutment plate and wherein said means to control damping action is comprised of hydraulic fluid and a control circuit.

13. The precession modulation control assembly of claim 11, further having means to vary said abutment plate angle such that the transmission's performance can be more optimally tailored to a specific and broader range of operating conditions.

14. A continuously variable differential transmission comprising:
a) an input shaft having an axis and a swash plate mounted thereon having a second axis, said swash plate rotating at an acute angle of said axis of said input shaft, and said swash plate retained to said shaft by a gimbaling mechanism allowing said swash plate, when skewed at its intended operating angle, to rotate freely about the input shaft through anti-friction means;
b) an axial array of linear dampers peripherally engaging the swash plate, said array of dampers having a centerline collinear with that of the input shaft, and rotating about said axis of rotation of said input shaft;
d) a carrier plate positioned opposite said swash plate constructed and arranged to cooperate with said array of dampers and being affixed to the input shaft such as to share a common axis about which the dampers are equally disposed and locked to the input shaft to rotate as a unit thereby imparting this rotation to the swash plate and creating a torsionally rigid input group;
d) an output shaft;
e) a transfer case enveloping said input group in a coaxial fashion through antifriction means with said transfer case being provided with antifriction means to rotate about said axis of said input shaft when mounted to a grounded structure while providing an output means to impart rotary motion to a load;
f) an abutment plate in communication with said output shaft and said transfer case, that provides an angled planar surface skewed at an acute angle from normal with respect to the axis of rotation of said input shaft, the acute angle of which matches that of the swash plate's intended operating angle while the array of linear dampers insure the swash plate positively engages the abutment plate should rotational moment be introduced through the input shaft, thereby inducing an alternating compression and expansion of said array of dampers as the swash plate rotates, while maintaining the skewed attitude dictated by the abutment plate; and
g) a means to control the speed differential between said input and output shafts accomplished by regulated damping rate of the plurality of dampers as a unit, said dampers maintaining a roughly equal damping rate and said damping rate being adjustable over a range.

15. The continuously variable differential transmission according to claim 14, further comprising:
an array of hydraulic dampers displacing hydraulic fluid by their cycling action, said fluid passing through a valve plate ported in a manner to divide the fluid flow into control and return circuits;
a valving means to regulate a pressure drop across said control and return circuits to regulate the damping rate;
a housing assembly for containing said continuously variable differential transmission while providing an atmospheric pressure reservoir for hydraulic fluids emanating from said transmission, and equipped with rotary seals at input and output shafts;
a make-up or charge pressure pump to insure a stable and adequate pressure drop across the control circuit.

16. The continuously variable differential transmission according to claim 15, having means to export the pressurized hydraulic fluid from control and return circuits by porting from the transmission via a valve plate, through the transmission housing for control and/or conditioning and/or power to run auxiliary systems.
